(19) United States
(12) Patent Application Publication
(10) Pub. No.: US 2022/0131205 A1
(43) Pub. Date: Apr. 28, 2022

(54) USE OF AN ESTER IN A COOLING COMPOSITION

(71) Applicant: TOTAL MARKETING SERVICES, PUTEAUX (FR)

(72) Inventor: Nicolas CHAMPAGNE, CALUIRE ET CUIRE (FR)

(21) Appl. No.: 17/438,525

(22) PCT Filed: Mar. 9, 2020
(86) PCT No.: PCT/EP2020/056186

§ 371 Date: Sep. 13, 2021

(30) Foreign Application Priority Data
Mar. 13, 2019 (FR) 1902567

(51) Int. Cl. H01M 10/613; H01M 10/0525; H01M 10/36

(52) U.S. Cl. CPC H01M 10/613; H01M 2220/20; H01M 10/36; H01M 10/0525

(57) ABSTRACT

Use of an ester in a cooling composition. The present invention relates to the use of a composition, for cooling a drive system of an electric or hybrid vehicle, comprising at least one ester having a kinematic viscosity, measured at −25° C., less than or equal to 200 mm²/s and an auto-ignition point greater than or equal to 350° C. It also relates to a composition capable of cooling a drive system, in particular the battery and/or the power electronics of an electric or hybrid vehicle, the composition comprising (i) at least one ester having a kinematic viscosity, measured at −25° C., less than or equal to 200 mm²/s and an auto-ignition point greater than or equal to 350° C. and (ii) at least one additive selected from antioxidants, friction modifiers, detergents, anti-wear additives, extreme pressure additives, dispersants, pour point depressants, defoamers and mixtures thereof.

### TECHNICAL FIELD

The present invention relates to the field of compositions for cooling a propulsion system of an electric or hybrid vehicle, and more particularly for cooling the battery and/or the power electronics of an electric or hybrid vehicle. The invention is more particularly directed toward proposing a cooling composition that is compatible with its use in a battery and/or in the power electronics, and which has improved stability at elevated temperatures, notably at the temperatures reached in the case of a thermal runaway.

### PRIOR ART

The changes in the international standards for the reduction of CO₂ emissions, but also for the reduction of energy consumption, has driven motor vehicle constructors toward proposing alternative solutions to combustion engines.

One of the solutions identified by motor vehicle constructors consists in replacing combustion engines with electric motors. The research aimed at reducing CO₂ emissions has thus led to the development of electric vehicles by a certain number of motor vehicle companies.

For the purposes of the present invention, the term “electric vehicle” denotes a vehicle comprising an electric motor as sole means of propulsion, whereas a hybrid vehicle comprises a combustion engine and an electric motor as combined means of propulsion.

For the purposes of the present invention, the term “propulsion system” denotes a system comprising the mechanical parts required for propelling an electric vehicle. The propulsion system thus more particularly encompasses an electric motor comprising the rotor-stator assembly of the power electronics (dedicated to regulating the speed), a transmission and a battery. The battery itself generally consists of a set of electric accumulators known as cells.

In general, it is necessary to use, in electric or hybrid vehicles, compositions to meet the constraints of lubricating and/or cooling the various parts of the propulsion system recalled above.

In particular, electric propulsion systems generate heat during their functioning via the electric motor, the power electronics and the batteries. Since the amount of heat generated is greater than the amount of heat normally dissipated to the environment, it is necessary to ensure cooling of the motor, the power electronics and the batteries. In general, the cooling takes place on several parts of the propulsion system which generate heat and/or the heat-sensitive parts of said system, so as to prevent dangerous temperatures from being reached, and notably the power electronics and the batteries.

Conventionally, it is known practice to cool electric motors with air or water, optionally combined with glycol. However, with the appearance of increasingly smaller motors of increasingly greater power, these cooling methods are no longer sufficient. Furthermore, the heat that may be generated by a battery, notably during rapid charging, cannot be extracted by the conventional methods used.

Thus, alternative methods for cooling propulsion systems, in particular batteries, have recently been proposed.

In this respect, lubricant compositions have been proposed for performing the twofold function of lubrication and cooling. Lubricant compositions are conventionally composed of one or more base oils which are generally combined with several additives intended for stimulating the lubricant performance of the base oils, for instance friction-modifying additives. By way of example, WO 2018/078290 proposes to use, in order to cool and/or lubricate a motorization system of an electric vehicle, a composition comprising at least one polyalkylene glycol obtained by polymerization or copolymerization of alkylene oxides comprising from 2 to 8 carbon atoms.

Despite the use of a cooling system, it is not possible to completely set aside the risk of the battery becoming overheated, for instance in the case of a defective cell, or else in the course of an accident during which a cell may be pierced. This may even lead to an explosion and to overall ignition of the battery, known as the “runaway effect”. Such overheating is notably feared in the context of the functioning of an Li-ion battery. Safety tests (UN RE100 standard) must thus be conducted on the batteries before they are marketed.

Consequently, it is desirable for the properties of the coolant fluid used in the propulsion systems of electric or hybrid vehicles, and notably in the batteries and/or the power electronics, to be conserved, even for the high temperatures that may be reached in the case of the overheating of the battery.

The invention is directed precisely towards proposing a novel composition, suitable for use for cooling the propulsion systems of electric or hybrid vehicles, in particular for cooling the batteries and/or the power electronics, w % bile at the same time remaining stable at high temperatures, which may be reached during overheating of the system, in particular up to a temperature of 350° C., or even 400° C.

The subject of the present invention is thus the use, for cooling a propulsion system, in particular the battery and/or the power electronics, of an electric or hybrid vehicle, of a composition comprising at least one ester having a kinematic viscosity, measured at −25° C. according to the standard ASTM D445, of less than or equal to 200 mm²/s and an auto-ignition temperature, measured according to the standard ASTM E659, of greater than or equal to 350° C.

The term “ester” means a compound comprising at least one ester function. It may notably be a monoester, diester or triester.

In the continuation of the text, and unless otherwise indicated, the term “ester according to the invention” will denote an ester which satisfies the abovementioned criteria in terms of kinematic viscosity and of auto-ignition temperature.

The auto-ignition temperature, known as the “AIT”, represents the temperature at and above which combustion self-initiates, without any flame being provided.

Also, the term “cooling composition” or “coolant composition” will be used in the continuation of the text to denote a composition used according to the invention, comprising at least one ester according to the invention, as defined above.

Advantageously, an ester according to the invention has a kinematic viscosity, measured at 25° C. according to the standard ASTM D445, of less than or equal to 20 mm²/s, preferably less than or equal to 15 mm²/s, in particular less than or equal to 10 mm²/s.

Moreover, an ester according to the invention advantageously has a particularly high auto-ignition temperature, preferably greater than or equal to 360° C., more preferentially greater than or equal to 380° C., in particular greater than or equal to 400° C.

A composition according to the invention may be totally or partly formed from one or more esters as defined previously. Preferably, a cooling composition according to the invention is formed from at least 30% by mass, preferably at least 50% by mass, more preferentially at least 70% by mass, even more preferentially at least 80% by mass, or even at least 90% by mass, of one or more esters according to the invention, relative to the total weight of the composition.

The addition of additives, preferably of one or more antioxidants, is possible, provided that their presence does not affect the properties afforded by the ester used according to the invention.

The ester used according to the invention may notably be chosen from:
a monoester, preferably a “branched” monoester formed between a monocarboxylic acid including at least one saturated or unsaturated, preferably saturated, branched hydrocarbon-based chain, and a monoalcohol including at least one linear or branched, saturated or unsaturated hydrocarbon-based chain; and
an ester comprising at least one heteroatom, preferably an oxygen atom, other than the oxygen atoms engaged in said ester function(s) of said ester; and mixtures thereof.

According to a particular embodiment, the ester used according to the invention is chosen from:
an ester, referred to in the continuation of the text as a “branched ester” formed between at least one carboxylic acid including at least one saturated or unsaturated, preferably saturated, branched hydrocarbon-based chain, and at least one alcohol including at least one linear or branched, saturated or unsaturated hydrocarbon-based chain, preferably a branched monoester;
an ester comprising at least one heteroatom, preferably an oxygen atom, other than the oxygen atoms engaged in said ester function(s) of said ester; and
mixtures thereof.

Preferably, a branched ester according to the invention is formed from at least one carboxylic acid including at least one branched hydrocarbon-based chain, which is preferably saturated, of 3 to 14 carbon atoms.

In particular, a branched ester according to the invention may be formed from at least one alcohol including at least one branched hydrocarbon-based chain, which is preferably saturated, in particular of 3 to 14 carbon atoms.

An ester according to the invention, comprising at least one heteroatom other than the oxygen atoms engaged in said ester function(s), may be formed from at least one alcohol comprising at least one heteroatom other than said oxygen atom(s) of said hydroxyl function(s) and/or from at least one carboxylic acid comprising at least one heteroatom other than said oxygen atom(s) of said carboxyl function(s), said heteroatom(s) being chosen from oxygen and nitrogen.

In particular, an ester according to the invention, comprising at least one heteroatom other than the oxygen atoms engaged in said ester function(s), is formed from at least one alcohol comprising at least one ether function, preferably from at least one alcohol including at least one linear or branched, preferably linear, saturated or unsaturated, preferably saturated, hydrocarbon-based chain, in particular of 3 to 14 carbon atoms, said hydrocarbon-based chain being interrupted with at least one oxygen atom.

An ester according to the invention is advantageously a monoester, diester or triester. It is preferably a monoester or a diester.

According to a particular embodiment, an ester according to the invention is a monoester, in particular a branched monoester as defined above.

According to another particular embodiment, an ester according to the invention is an ester comprising at least one heteroatom other than the oxygen atoms engaged in said ester function(s). It may be a monoester, diester or triester, preferably a diester.

Preferably, an ester according to the invention is a branched monoester as defined above or a diester comprising at least one heteroatom, preferably two heteroatoms, in particular two oxygen atoms, other than the oxygen atoms engaged in the ester functions of the diester.

Thus, according to a particularly preferred implementation variant, a cooling composition according to the invention comprises at least one monoester formed between a monocarboxylic acid including a saturated or unsaturated hydrocarbon-based chain, which is preferably branched, preferably of 3 to 14 carbon atoms, and a monoalcohol including a linear or branched, saturated or unsaturated hydrocarbon-based chain, preferably of 1 to 14 carbon atoms.

Advantageously, a monoester according to the invention may be a monoester formed between a saturated branched C₉ monocarboxylic acid and a saturated branched C₉ monoalcohol, such as 3,5,5-trimethylhexyl 3,5,5-trimethylhexanoate.

In particular, a composition according to the invention may comprise a mixture of monoesters formed between a saturated branched C₉ monocarboxylic acid, for example 3,5,5-trimethylhexanoic acid, and a mixture of saturated branched C₈-C₁₀ monoalcohols, preferably a mixture of saturated branched C₉ monoalcohol isomers.

According to another variant of the invention, a cooling composition according to the invention comprises at least one diester formed between a dicarboxylic acid including a saturated or unsaturated linear hydrocarbon-based chain, preferably of 3 to 14 carbon atoms, and a monoalcohol including a linear or branched, saturated or unsaturated hydrocarbon-based chain, preferably of 2 to 14 carbon atoms, interrupted with at least one heteroatom, preferably with an oxygen atom.

Advantageously, a diester according to the invention may be formed between a saturated linear C₄-C₁₀ dicarboxylic acid and a monoalcohol comprising a saturated linear C₄-C₁₀ hydrocarbon-based chain interrupted with an oxygen atom. It may be, for example, dibutylglycol adipate.

As emerges from the examples that follow, the inventors have found that the esters according to the invention make it possible advantageously to combine good viscosity properties, suitable for their use for cooling a battery and/or power electronics, and a particularly high auto-ignition temperature, which thus ensures stability of the cooling composition, in particular resistance to ignition, in the case of overheating of the battery.

Thus, advantageously, the esters according to the invention have a kinematic viscosity, measured at 25° C. according to the standard ASTM D445, of less than or equal to 20 mm²/s, preferably less than or equal to 15 mm²/s, in particular less than or equal to 10 mm²/s.

Moreover, the esters according to the invention advantageously have a particularly high auto-ignition temperature, preferably greater than or equal to 360° C., more preferentially greater than or equal to 380° C., in particular greater than or equal to 400° C.

Advantageously, it is thus possible to gain access, via the use of one or more esters according to the invention, in particular as defined above, to a cooling composition which simultaneously has a viscosity that is suitable for its use in a propulsion system, notably of a battery and/or of the power electronics, of an electric or hybrid vehicle, and excellent resistance to ignition.

A cooling composition according to the invention may be more particularly intended to be placed in direct contact with battery packs of electric vehicles, notably Li-ion or nickel-cadmium (Ni—Cd) batteries.

A cooling composition according to the invention advantageously makes it possible to retard or to prevent the thermal runaway of said battery pack by preventing the cells from reaching a critical temperature and thus from undergoing thermal runaway.

A cooling composition used according to the invention also has excellent electrical insulation properties, which makes it particularly suitable for use in hybrid and electric vehicles. The insulating properties may be evaluated by measuring the electrical resistivity of the cooling composition, notably according to the standard ASTM D1169.

The invention also relates to a process for cooling at least one part of a propulsion system of an electric or hybrid vehicle, in particular the battery and/or the power electronics, comprising at least one step of placing at least said part, in particular said battery, for example a lithium-ion or nickel-cadmium battery, in contact with a composition comprising at least one ester according to the invention, as defined previously.

According to another of its aspects, the invention also relates to a composition that is capable of cooling a propulsion system, in particular the battery and/or the power electronics, of an electric or hybrid vehicle, said composition comprising:

(i) at least one ester according to the invention, as defined previously; and

(ii) at least one additive chosen from antioxidants, antifoams, pour-point improvers, anticorrosion agents, wear-resistance additives, friction modifiers, detergents, extreme-pressure additives, dispersants, and mixtures thereof.

Advantageously, a composition according to the invention may have combined cooling and lubricant properties.

Thus, according to a particular embodiment, a composition according to the invention, used in a propulsion system of an electric or hybrid vehicle, makes it possible, besides its cooling function, to gain access to good properties in terms of lubrication of the parts of the propulsion system, for example for the lubrication of the transmission in an electric or hybrid vehicle.

Other features, variants and advantages of the use of an ester according to the invention will emerge more clearly on reading the description and the examples that follow, which are given as nonlimiting illustrations of the invention.

In the continuation of the text, the expressions “between . . . and . . . ”, “ranging from . . . to . . . ” and “varying from . . . to . . . ” are equivalent and are intended to mean that the limits are included, unless otherwise mentioned.

Unless otherwise indicated, the expression “comprising a(n)” should be understood as “including at least one”.

### BRIEF DESCRIPTION OF THE DRAWINGS

FIG. 1 schematically represents a propulsion system of an electric or hybrid vehicle.

### DETAILED DESCRIPTION

Ester According to the Invention

As mentioned above, the ester used according to the invention has a kinematic viscosity, measured at −25° C. according to the standard ASTM D445, of less than or equal to 200 mm²/s and an auto-ignition temperature, measured according to the standard ASTM E659, of greater than or equal to 350° C.

Preferably, an ester according to the invention has a kinematic viscosity, measured at −25° C. according to the standard ASTM D445, of less than or equal to 150 mm²/s, in particular less than 120 mm²/s, preferably less than or equal to 100 mm²/s, notably ranging from 20 to 100 mm²/s and more particularly ranging from 40 to 70 mm²/s.

According to a particular embodiment, an ester according to the invention advantageously has a kinematic viscosity, measured at 25° C. according to the standard ASTM D445, of less than or equal to 20 mm²/s, preferably less than or equal to 15 mm²/s, in particular less than or equal to 10 mm²/s.

Also, the ester used according to the invention advantageously has an auto-ignition temperature, measured according to the standard ASTM E659, of greater than or equal to 360° C., in particular greater than or equal to 380° C. and more particularly greater than or equal to 400° C.

An ester according to the invention is preferably a monoester, a diester or a triester, preferably a monoester or diester. It may preferably be a monoester formed between a monocarboxylic acid and a monoalcohol. It may also be a diester formed between a dicarboxylic acid and a monoalcohol, or formed between a monocarboxylic acid and a diol.

The ester used according to the invention may be saturated or unsaturated, preferably saturated.

According to a particularly preferred embodiment, the ester used according to the invention is chosen from:
a monoester, preferably a “branched” monoester formed between a monocarboxylic acid including at least one saturated or unsaturated, preferably saturated, branched hydrocarbon-based chain, and a monoalcohol including at least one linear or branched, saturated or unsaturated hydrocarbon-based chain; and
an ester comprising at least one heteroatom, preferably an oxygen atom, other than the oxygen atoms engaged in said ester function(s) of said ester; and mixtures thereof.

According to a particular embodiment, the ester used according to the invention is chosen from:
a branched ester, in particular a branched monoester, formed between at least one carboxylic acid including at least one saturated or unsaturated, preferably saturated, branched hydrocarbon-based chain, and at least one alcohol including at least one linear or branched, saturated or unsaturated hydrocarbon-based chain;
an ester comprising at least one heteroatom, preferably an oxygen atom, other than the oxygen atoms engaged in said ester function(s) of said ester; and
mixtures thereof.

For the purposes of the present invention, the term “carboxylic acid” is intended to denote a compound comprising at least one carboxyl function. It may be a monocarboxylic or polycarboxylic acid. It is more preferentially a monocarboxylic, dicarboxylic, tricarboxylic or tetracarboxylic acid. Preferably, the carboxylic acid is a monocarboxylic acid.

For the purposes of the present invention, the term “alcohol” is intended to denote a compound including at least one hydroxyl function. It may be a monoalcohol or a polyol. Preferably, it is a monoalcohol, diol or triol. Preferably, the alcohol is a monoalcohol.

For the purposes of the invention, the term “hydrocarbon-based chain” is intended to denote a linear or branched, saturated or unsaturated alkyl or alkylene chain. The hydrocarbon-based chain may optionally be interrupted with one or more heteroatoms, in particular with one or more oxygen atoms. Preferably, the hydrocarbon-based chain is a linear or branched, saturated or unsaturated alkyl or alkylene chain consisting of carbon and hydrogen atoms. It preferably comprises from 1 to 14 carbon atoms, in particular from 3 to 10 carbon atoms and notably from 4 to 9 carbon atoms.

According to a particular embodiment, the ester used according to the invention is a monoester formed between a monocarboxylic acid and a monoalcohol.

A monoester according to the invention may more particularly be formed between a monocarboxylic acid including a linear or branched, saturated or unsaturated, preferably saturated, hydrocarbon-based chain, preferably of 1 to 14 carbon atoms, in particular of 3 to 14 carbon atoms, notably of 5 to 12 carbon atoms and more particularly of 6 to 10 carbon atoms, and a monoalcohol containing a linear or branched, saturated or unsaturated hydrocarbon-based chain, preferably of 1 to 14 carbon atoms, in particular of 3 to 14 carbon atoms, notably of 5 to 12 carbon atoms and more particularly of 6 to 10 carbon atoms.

Preferably, a monoester according to the invention is a “branched” monoester as defined in the continuation of the text.

It may notably be a monoester formed between a monocarboxylic acid including a branched hydrocarbon-based chain, preferably of 3 to 14 carbon atoms, which is saturated or unsaturated, preferably saturated; and a monoalcohol including at least one linear or branched hydrocarbon-based chain, preferably of 1 to 14 carbon atoms, which is saturated or unsaturated, preferably saturated.

In one particular embodiment, the monoester according to the invention is obtained from a saturated, preferably branched, C₈ to C₁₀, preferably C₉, monocarboxylic acid, in particular 3,5,5-trimethylhexanoic acid, and from a saturated, preferably branched, C₈ to C₁₀, preferably C₉, monoalcohol, for example from 3,5,5-trimethylhexanol or an isomer thereof.

According to a particular embodiment, the ester used according to the invention is a “branched ester”, formed between.
at least one carboxylic acid including at least one branched hydrocarbon-based chain, preferably of 3 to 14 carbon atoms, which is saturated or unsaturated, preferably saturated; and
at least one alcohol including at least one linear or branched hydrocarbon-based chain, preferably of 1 to 14 carbon atoms, which is saturated or unsaturated, preferably saturated. The branched ester according to the invention is preferably a monoester, a diester or a triester.

According to a particular embodiment, the branched ester according to the invention may be a monoester formed between a monocarboxylic acid and a monoalcohol.

According to another particular embodiment, the branched ester according to the invention may be a diester, formed between one diol compound and two monocarboxylic acids, or else formed between one dicarboxylic acid (diacid) and two monoalcohols.

As mentioned previously, a branched ester used according to the invention is obtained from at least one carboxylic acid including at least one branched hydrocarbon-based chain, which is preferably saturated.

The branched hydrocarbon-based chain of said carboxylic acid may more particularly comprise from 3 to 14 carbon atoms, in particular from 5 to 12 carbon atoms and more particularly from 6 to 10 carbon atoms.

Preferably, it may be formed from a linear main chain containing from 4 to 10 carbon atoms, in particular from 5 to 8 carbon atoms, said main chain containing at least one alkyl side group, preferably at least two alkyl side groups, in particular at least three alkyl side groups, said alkyl groups more particularly being C₁ to C₄, preferably C₁ to C₃, notably C₁-C₂, for example methyl groups.

According to one implementation variant, the branched ester according to the invention is obtained from a monocarboxylic acid containing a hydrocarbon-based chain, in particular as defined previously.

In one particular embodiment, the branched ester according to the invention is obtained from a branched, saturated C₈ to C₁₀ and preferably C₉ monocarboxylic acid, in particular 3,5,5-trimethylhexanoic acid.

The alcohol from which a branched ester according to the invention is formed may comprise a branched or non-branched (linear) hydrocarbon-based chain, which is preferably saturated.

The hydrocarbon-based chain of said alcohol may more particularly comprise from 1 to 14 carbon atoms, in particular from 3 to 12 carbon atoms and more particularly from 6 to 10 carbon atoms.

According to a particular embodiment, a branched ester according to the invention is formed from at least one alcohol comprising a branched hydrocarbon-based chain, in particular containing from 3 to 14 carbon atoms, in particular from 5 to 12 carbon atoms and more particularly from 6 to 10 carbon atoms.

The branched hydrocarbon-based chain may be formed from a main linear chain containing from 4 to 10 carbon atoms, in particular from 5 to 8 carbon atoms, said main chain containing at least one alkyl side group, preferably at least two alkyl side groups, in particular at least three alkyl side groups, said alkyl groups more particularly being C₁ to C₄, preferably C₁ to C₃, notably C₁-C₂, for example methyl groups.

According to one implementation variant, the branched ester according to the invention is obtained from a monoalcohol containing a hydrocarbon-based chain, in particular as defined previously, preferably a branched hydrocarbon-based chain.

In one particular embodiment, the branched ester according to the invention is obtained from a branched, saturated C₈ to C₁₀ and preferably C₉ monoalcohol, for example from 3,5,5-trimethylhexanol or an isomer thereof.

According to another particular embodiment, the ester used according to the invention is an ester comprising at least one heteroatom, preferably an oxygen atom, other than the oxygen atoms engaged in said ester function(s) of said ester.

It may notably be a monoester, diester or triester. The ester comprising at least one heteroatom, preferably an oxygen atom, other than the oxygen atoms engaged in said ester function(s) of said ester, may be a branched or non-branched ester.

According to a particular embodiment, the ester used according to the invention is a diester comprising at least one heteroatom, preferably an oxygen atom, other than the oxygen atoms engaged in said ester function(s) of said ester.

Preferably, the ester comprising at least one heteroatom, preferably an oxygen atom, other than the oxygen atoms engaged in said ester function(s) of said ester according to the invention is formed between at least one carboxylic acid and at least one alcohol comprising at least one ether function, preferably from at least one alcohol comprising at least one linear or branched, preferably linear, saturated or unsaturated, preferably saturated, hydrocarbon-based chain, in particular of 2 to 14 carbon atoms, said hydrocarbon-based chain being interrupted with at least one oxygen atom.

The hydrocarbon-based chain of said alcohol may more particularly comprise from 4 to 10 carbon atoms, in particular from 5 to 8 carbon atoms, and may be interrupted with one or more oxygen atoms, preferably with one oxygen atom.

The carboxylic acid from which is formed an ester according to the invention, comprising at least one heteroatom other than the oxygen atoms engaged in said ester function(s) of said ester, may comprise at least one linear or branched, preferably linear, saturated or unsaturated, preferably saturated, in particular C₃ to C₁₄, in particular C₄ to C₁₀ and notably C₄ to C₈ hydrocarbon-based chain.

According to a particular embodiment, the ester comprising at least one heteroatom other than the oxygen atoms engaged in said ester function(s) is a diester formed between a dicarboxylic acid and at least one monoalcohol, including a linear or branched, saturated or unsaturated hydrocarbon-based chain, preferably of 2 to 14 carbon atoms, interrupted with at least one heteroatom, preferably with an oxygen atom.

Preferably, the dicarboxylic acid includes a linear or branched, preferably linear, saturated or unsaturated, preferably saturated, in particular C₃-C₁₄, preferably C₄-C₁₀ and notably C₆-C₈ hydrocarbon-based chain. It may be, for example, adipic acid.

Preferably, the monoalcohol including a hydrocarbon-based chain interrupted with at least one heteroatom has a saturated linear hydrocarbon-based chain, in particular of 3 to 14 carbon atoms, preferably of 4 to 10 carbon atoms and more particularly of 4 to 8 carbon atoms, said chain being interrupted with one or more oxygen atoms, preferably with one oxygen atom.

Such a monoalcohol may more particularly include a C₂ to C₄ alkylene chain, bearing at least one C₂ to C₆ and in particular C₄ alkoxy group. It may be, for example, butylglycol.

In a particular embodiment, the ester used according to the invention is dibutylglycol adipate.

It is understood that the definitions given above for the carboxylic acid and the alcohol may be combined, as far as is possible, to define other particular embodiments.

An ester according to the invention may more particularly correspond to formula (I) below:

[Chem 1]

G¹-C(O)—O-G² (I)

in which:
G¹ represents a linear or branched, preferably branched, saturated or unsaturated hydrocarbon-based chain, in particular containing from 3 to 14 carbon atoms, said hydrocarbon-based chain being optionally interrupted with one or more heteroatoms, such as oxygen atoms, and/or optionally bearing one or more groups R¹—O—C(O)—, preferably one or two groups R¹—O—C(O)—, with R¹ representing a linear or branched, saturated or unsaturated hydrocarbon-based chain, preferably of 1 to 13 carbon atoms, optionally interrupted with one or more heteroatoms, such as oxygen atoms; and
G² represents a saturated or unsaturated, linear or branched, preferably branched, hydrocarbon-based chain, in particular containing from 1 to 14 carbon atoms, said hydrocarbon-based chain being optionally interrupted with one or more heteroatoms, such as oxygen atoms, and/or optionally bearing one or more groups —O—C(O)—R², preferably one or two groups —O—C(O)—R², with R² representing a linear or branched, preferably branched, saturated or unsaturated hydrocarbon-based chain, preferably of 3 to 13 carbon atoms, optionally interrupted with one or more heteroatoms, such as oxygen atoms.

According to a particular embodiment, an ester according to the invention may more particularly correspond to formula (I) below:

[Chem 1]

G¹-C(O)—O-G² (I)

in which:
G¹ represents a saturated or unsaturated hydrocarbon-based chain, which is preferably branched, in particular containing from 3 to 14 carbon atoms, said hydrocarbon-based chain possibly bearing one or more groups R¹—O—C(O)—, preferably one or two groups R¹—O—C(O)—, with R¹ representing a linear or branched, saturated or unsaturated hydrocarbon-based chain, preferably of 1 to 13 carbon atoms, optionally interrupted with one or more heteroatoms, such as oxygen atoms; and
G² represents a saturated or unsaturated, linear or branched, preferably branched, hydrocarbon-based chain, in particular containing from 1 to 14 carbon atoms, said hydrocarbon-based chain being optionally interrupted with one or more heteroatoms, such as oxygen atoms, and/or optionally bearing one or more groups —O—C(O)—R², preferably one or two groups —O—C(O)—R², with R² representing a linear or branched, preferably branched, saturated or unsaturated hydrocarbon-based chain, preferably of 3 to 13 carbon atoms.

Preferably, G¹ represents an alkyl group, which is preferably branched, in particular of C₃ to C₁₃, notably of C₄ to C₁₁ and more particularly of C₅ to C₉, or a group R¹—O—C(O)-A¹-, with A¹ representing an alkylene group, in particular of C₂ to C₁₂, notably of C₃ to C₁₀, and R¹ being as defined previously.

Preferably, G² represents a linear or branched alkyl chain, in particular of C₁ to C₁₄, in particular C₃ to C₁₂ and more particularly C₆ to C₁₀, optionally interrupted with one or more oxygen atoms, or a group -A²-O—C(O)—R², with A² representing an alkylene group in particular of C₁ to C₁₃, and R² being as defined previously, R² preferably representing an alkyl group, which is preferably branched, of C₃ to C₁₃.

According to a first implementation variant, an ester according to the invention may be of the abovementioned formula (I), in which:
G¹ represents an alkyl group, which is preferably branched, in particular of C₃ to C₁₃, notably C₄ to C₁₁ and more particularly C₅ to C₉.

G¹ is preferably formed from a main linear alkyl chain, in particular of C₃ to C₉, notably C₄ to C₇, said main chain containing at least one alkyl side group, preferably at least two alkyl side groups, in particular at least three alkyl side groups, said alkyl side groups more particularly being C₁ to C₄, preferably C₁ to C₃, notably C₁-C₂, for example methyl groups.

Advantageously, G¹ may represent a 2,4,4-trimethylpentyl group.
G² represents a linear or branched alkyl group, in particular of C₁ to C₁₄, in particular C₃ to C₁₂ and more particularly C₆ to C₁₀.

According to a particularly advantageous variant, G² represents a branched alkyl chain, in particular of C₃ to C₁₄, notably C₆ to C₁₂ and more particularly C₈ to C₁₀.

Such a branched alkyl group may notably be formed from a main linear alkyl chain, in particular of C₄ to C₁₀, in particular C₅ to C₈, said main chain containing at least one alkyl side group, preferably at least two alkyl side groups, in particular at least three alkyl side groups, said alkyl side groups more particularly being C₁ to C₄, preferably C₁ to C₃, notably C₁-C₂, for example methyl groups.

Advantageously, G² may represent a branched C₉ alkyl group, for example 3,5,5-trimethylhexyl or an isomer thereof.

According to another implementation variant, an ester according to the invention may be of the abovementioned formula (I), in which:
G¹ represents an alkyl group, which is preferably branched, in particular of C₃ to C₁₃, notably C₄ to C₁₁ and more particularly C₅ to C₉.

G¹ is preferably formed from a main linear alkyl chain, in particular of C₃ to C₉, notably C₄ to C₇, said main chain containing at least one alkyl side group, preferably at least two alkyl side groups, in particular at least three alkyl side groups, said alkyl side groups more particularly being C₁ to C₄, preferably C₁ to C₃, notably C₁-C₂, for example methyl groups. Advantageously, G¹ may represent a 2,4,4-trimethylpentyl group.
G² represents a group -A²-O—C(O)—R², in which A² and R² are as defined previously.

Preferably, A² represents a C₁ to C₁₃, in particular C₃ to C₁₂ and more particularly C₆ to C₁₀ alkylene group.

According to a particular embodiment. R² may be as defined previously for the group G¹; preferentially, R² is identical to G¹.

According to a particular embodiment, an ester according to the invention may be of the abovementioned formula (I), in which:
G¹ represents a linear or branched, saturated or unsaturated hydrocarbon-based chain, in particular containing from 3 to 14 carbon atoms;
G² represents a group -A²-O—C(O)—R², in which A² and R² are as defined previously;

at least one of the hydrocarbon-based chains, in particular both the hydrocarbon-based chains, represented by G¹ and R² being interrupted with one or more heteroatoms, preferably with one or more oxygen atoms, in particular with one oxygen atom.

According to yet another implementation variant, an ester according to the invention may be of the abovementioned formula (I), in which:
G² represents a saturated or unsaturated, linear or branched hydrocarbon-based chain, in particular containing from 1 to 14 carbon atoms, said hydrocarbon-based chain being optionally interrupted with one or more heteroatoms, preferably with one or more oxygen atoms. In particular, G² may represent an alkyl chain, which is preferably linear, including from 1 to 14 carbon atoms, in particular from 3 to 12 carbon atoms and more particularly from 6 to 10 carbon atoms, and interrupted with at least one oxygen atom, preferably with one oxygen atom;
G¹ represents a group R¹—O—C(O)-A¹-, in which A¹ and R¹ are as defined previously.

In particular, R¹ may be as defined previously for the group G²; preferentially, R¹ is identical to G².

Preferably, A¹ represents a linear or branched C₃ to C₁₃ and in particular C₄ to C₁₁ alkylene group,

Preferably, at least one of the hydrocarbon-based chains, in particular both the hydrocarbon-based chains, represented by G² and R¹ is interrupted with one or more heteroatoms, preferably with one or more oxygen atoms, in particular with one oxygen atom.

According to a particularly preferred embodiment, an ester according to the invention is chosen from:

(i) a branched monoester formed between:
a monocarboxylic acid, containing a saturated branched hydrocarbon-based chain, preferably including from 3 to 14 carbon atoms, in particular as defined above; and
a monoalcohol containing a saturated, preferably branched hydrocarbon-based chain, preferably including from 3 to 14 carbon atoms, in particular as defined above, or

(ii) a diester formed between:
a dicarboxylic acid, containing a saturated linear hydrocarbon-based chain, preferably including from 3 to 14 carbon atoms, in particular from 4 to 10 carbon atoms; and
a monoalcohol containing a saturated, linear hydrocarbon-based chain, interrupted with an oxygen atom, preferably including from 3 to 14 carbon atoms, in particular from 4 to 10 carbon atoms.

Advantageously, the ester according to the invention may be a monoester formed between 3,5,5-trimethylhexanoic acid and 3,5,5-trimethylhexanol or an isomer thereof, or else a diester formed between adipic acid and butylglycol.

The esters according to the invention may be commercially available or prepared according to synthetic methods known to those skilled in the art. These synthetic methods more particularly involve an esterification reaction between at least one alcohol compound and at least one carboxylic acid compound.

Needless to say, it falls to a person skilled in the art to adjust the synthetic conditions in order to obtain an ester according to the invention.

Advantageously, a branched ester according to the invention has a kinematic viscosity, measured at 25° C. according to the standard ASTM D445, of less than or equal to 20 mm²/s, preferably less than or equal to 15 mm²/s, in particular less than or equal to 10 mm²/s.

Advantageously, a branched ester according to the invention has a kinematic viscosity, measured at −25° C. according to the standard ASTM D445, of less than or equal to 150 mm²/s, in particular less than or equal to 120 mm²/s, notably ranging from 20 to 100 mm²/s and more particularly ranging from 40 to 70 mm²/s.

Advantageously, a branched ester according to the invention has an auto-ignition temperature of greater than or equal to 360° C., in particular greater than or equal to 380° C. and more particularly greater than or equal to 400° C.

It is understood that, in the context of the present invention, an ester according to the invention, in particular a branched ester according to the invention, may be in the form of a mixture of at least two esters according to the invention, in particular as defined previously.

The ester or the mixture of esters according to the invention may represent more than 30% by mass, preferably more than 50% by mass, more preferentially more than 70% by mass, even more preferentially more than 80% by mass, in particular more than 90% by mass, more particularly more than 95% by mass, or even more than 98% by mass, relative to the total mass of the cooling composition according to the invention.

In particular, a cooling composition used according to the invention may comprise between 30% and 100% by mass of an ester or mixture of esters according to the invention, more particularly between 50% and 99.5% by mass, preferably between 70% and 99% by mass, more preferentially between 80% and 99% by mass, or even between 80% and 95% by mass, relative to the total mass of said composition.

According to a particular embodiment, a cooling composition according to the invention may be formed to more than 95% by mass, in particular to more than 98% by mass, of one or more esters according to the invention, in particular one or more branched esters according to the invention.

Additional Base Oil(s)

A cooling composition used according to the invention may comprise, besides one or more esters according to the invention, one or more base oils other than the esters according to the invention.

Said base oil(s), which may be present in a cooling composition according to the invention, are appropriately chosen, with regard to their compatibility with said ester(s) used according to the invention.

It may be a mixture of several base oils, for example a mixture of two, three or four base oils.

Preferably, the base oil or mixture of additional base oils, used in a cooling composition according to the invention, may have a kinematic viscosity, measured at 100° C. according to the standard ASTM D445, ranging from 1.5 to 8 mm²/s, in particular from 1.5 to 6.1 mm²/s, more particularly from 1.5 to 4.1 mm²/s and even more particularly from 1.5 to 2.1 mm²/s.

The base oils may be chosen from oils of mineral or synthetic origin belonging to groups I to V according to the classes defined by the API classification (or equivalents thereof according to the ATIEL classification) and presented in table 1 below or mixtures thereof.

TABLE 1

| | Content of | | Viscosity index |
|---|---|---|---|
| | saturates | Sulfur content | (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydrocracked or | | | |
| hydroisomerized oils | | | |

| | |
|---|---|
| Group IV | Poly-α-olefins (PAO) |
| Group V | Esters and other bases not included in groups I to IV |

The mineral base oils include all types of base oils obtained by atmospheric and vacuum distillation of crude oil, followed by refining operations such as solvent extraction, deasphalting, solvent deparaffinning, hydrotreating, hydrocracking, hydroisomerization and hydrofinishing.

Mixtures of synthetic and mineral oils, which may be biobased, may also be used.

There is generally no limit as regards the use of different additional base oils for preparing the cooling compositions, apart from the fact that they must have properties, notably in terms of viscosity index, sulfur content or resistance to oxidation, that are suitable for use for the propulsion systems of an electric or hybrid vehicle.

The base oils may also be chosen from synthetic oils, such as certain esters of carboxylic acids and of alcohols, other than the ester defined according to the invention, from poly-α-olefins (PAO) and from polyalkylene glycols (PAG) obtained by polymerization or copolymerization of alkylene oxides comprising from 2 to 8 carbon atoms, in particular from 2 to 4 carbon atoms.

The PAOs used as base oils are obtained, for example, from monomers comprising from 4 to 32 carbon atoms, for example from octene or decene.

The mass-average molecular mass of the PAO may vary quite broadly. Preferably, the mass-average molecular mass of the PAO is less than 600 Da. The mass-average molecular mass of the PAO may also range from 100 to 600 Da, from 150 to 600 Da or from 200 to 600 Da.

For example, the PAOs used in the context of the invention, having a kinematic viscosity, measured at 100° C. according to the standard ASTM D445, ranging from 1.5 to 8 mm²/s are sold commercially by Ineos under the brand names Durasyn® 162, Durasyn® 164, Durasyn® 166 and Durasyn® 168.

Advantageously, the additional base oil(s) are chosen from poly-α-olefins (PAOs).

It falls to a person skilled in the art to adjust the content of additional base oil(s) present in a cooling composition according to the invention.

In particular, a cooling composition according to the invention may comprise less than 70% by mass of additional base oil(s), in particular less than 50% by mass, notably less than 30% by mass, or even less than 20% by mass or less than 10% by mass and more particularly less than 5% by mass, relative to the total mass of said composition.

Additives

A cooling composition according to the invention may also comprise one or more additives known to those skilled in the art in the field of the lubrication and/or cooling of the propulsion systems of electric or hybrid vehicles.

The additives that may be incorporated into a composition according to the invention may be chosen from antioxidants, pour-point-depressant additives, antifoams, anticorrosion agents, wear-resistance and/or extreme-pressure additives, friction modifiers, detergents, dispersants and mixtures thereof, in particular from antioxidants, pour-point-depressant additives, antifoams and anticorrosion agents.

Preferably, a cooling composition according to the invention may also comprise one or more additives chosen from antioxidants, antifoams, pour-point improvers and anticorrosion agents.

The addition of one or more additives chosen from wear-resistance additives, friction modifiers, detergents, extreme-pressure additives and dispersants may also prove to be advantageous in the context of using the cooling composition according to the invention as a multi-purpose fluid, for example for cooling the battery and/or the power electronics, and for lubricating the parts of the propulsion system, for example the transmission, in an electric or hybrid vehicle.

It is understood that the nature and amount of additives used are chosen so as not to affect the properties of the cooling composition imparted by the ester according to the invention. These additives may be introduced individually and/or in the form of a mixture such as those already available for sale for commercial lubricant formulations for vehicle engines, with a performance level as defined by the ACEA (Association des Constructeurs Européens d'Automobiles) and/or the API (American Petroleum Institute), which are well known to those skilled in the art.

Said additive(s) may be present in the cooling composition according to the invention in a content of less than or equal to 10% by mass, in particular less than or equal to 5% by mass and more particularly ranging from 0.01% to 3% by mass, relative to the total mass of said composition.

A cooling composition used according to the invention may thus comprise at least one antioxidant additive.

According to another of its aspects, the invention thus relates to a cooling composition that is in particular capable of cooling a propulsion system, in particular the battery and/or the power electronics, of an electric or hybrid vehicle, said composition comprising (i) at least one branched ester as defined previously, and (ii) at least one antioxidant additive.

The antioxidant additive generally makes it possible to retard the degradation of the composition in service. This degradation may notably be reflected by the formation of deposits, the presence of sludges, or by an increase in the viscosity of the composition.

The antioxidant additives notably act as free-radical inhibitors or hydroperoxide destroyers. Among the commonly used antioxidant additives, mention may be made of antioxidant additives of phenolic type, antioxidant additives of amine type and phospho-sulfur-based antioxidant additives. Some of these antioxidant additives, for example the phospho-sulfur-based antioxidant additives, may be ash generators. The phenolic antioxidants additives may be ash-free or may be in the form of neutral or basic metal salts. The antioxidants additives may notably be chosen from sterically hindered phenols, sterically hindered phenol esters and sterically hindered phenols comprising a thioether bridge, diphenylamines, diphenylamines substituted with at least one C₁-C₁₂ alkyl group, N,N′-dialkyl-aryl-diamines, and mixtures thereof.

Preferably according to the invention, the sterically hindered phenols are chosen from compounds comprising a phenol group, in which at least one carbon vicinal to the carbon bearing the alcohol function is substituted with at least one C₁-C₁₀ alkyl group, preferably a C₁-C₆ alkyl group, preferably a C₄ alkyl group, preferably with a tert-butyl group.

Amine compounds are another class of antioxidant additives that may be used, optionally in combination with the phenolic antioxidants additives. Examples of amine compounds are aromatic amines, for example the aromatic amines of formula NR⁴R⁵R⁶ in which R⁴ represents an optionally substituted aliphatic or aromatic group, R⁵ represents an optionally substituted aromatic group, R⁶ represents a hydrogen atom, an alkyl group, an aryl group or a group of formula R⁷S(O)_{z}R⁸ in which R⁷ represents an alkylene group or an alkenylene group, R⁸ represents an alkyl group, an alkenyl group or an aryl group and z represents 0, 1 or 2.

Sulfurized alkylphenols or the alkali metal and alkaline-earth metal salts thereof may also be used as antioxidant additives.

Another class of antioxidant additives is that of copper compounds, for example copper thio- or dithio-phosphates, copper salts of carboxylic acids, and copper dithiocarbamates, sulfonates, phenates and acetylacetonates. Copper I and II salts and succinic acid or anhydride salts may also be used.

Advantageously, a cooling composition comprises at least one ash-free antioxidant additive.

The additive(s) may be used, in a cooling composition according to the invention, in a proportion of from 0.1% to 2% by mass relative to the total mass of the composition.

A cooling composition according to the invention may comprise at least one wear-resistance and/or extreme-pressure additive.

The wear-resistance additives and the extreme-pressure additives protect the friction surfaces by forming a protective film adsorbed onto these surfaces.

A wide variety of wear-resistance additives exists. Preferably, the wear-resistance additives are chosen from phospho-sulfur-based additives, such as metal alkylthiophosphates, in particular zinc alkylthiophosphates and more specifically zinc dialkyldithiophosphates or ZnDTP. The preferred compounds are of formula Zn((SP(S)(OR²)(OR³))₂, in which R² and R³, which may be identical or different, independently represent an alkyl group, preferentially an alkyl group including from 1 to 18 carbon atoms.

Amine phosphates are also wear-resistance additives that may be employed in a composition according to the invention. However, the phosphorus introduced by these additives may act as a poison for the catalytic systems of motor vehicles since these additives are ash generators. These effects can be minimized by partially replacing the amine phosphates with additives which do not introduce phosphorus, for instance polysulfides, notably sulfur-based olefins.

A cooling composition may comprise from 0.01% to 6% by mass, preferentially from 0.05% to 4% by mass and more preferentially from 0.1% to 2% of wear-resistance additives and of extreme-pressure additives, by mass relative to the total mass of the composition.

A cooling composition according to the invention may also comprise an antifoam.

The antifoam may be chosen from silicones.

A cooling composition may comprise from 0.01% to 2% by mass or from 0.01% to 5% by mass, preferentially from 0.1% to 1.5% by mass or from 0.1% to 2% by mass of antifoam, relative to the total weight of the composition.

A cooling composition according to the invention may comprise at least one friction-modifying additive.

The friction-modifying additive may be chosen from a compound providing metal elements and an ash-free compound. Among the compounds providing metal elements, mention may be made of complexes of transition metals such as Mo. Sb, Sn, Fe, Cu or Zn, the ligands of which may be hydrocarbon-based compounds comprising oxygen, nitrogen, sulfur or phosphorus atoms. The ash-free friction-modifying additives are generally of organic origin and may be chosen from fatty acid monoesters of polyols, alkoxylated amines, alkoxylated fatty amines, fatty epoxides, borate fatty epoxides, fatty amines or fatty acid esters of glycerol. According to the invention, the fatty compounds comprise at least one hydrocarbon-based group comprising 10 to 24 carbon atoms.

A cooling composition may comprise from 0.01% to 2% by mass or from 0.01% to 5% by mass, preferentially from 0.1% to 1.5% by mass or from 0.1% to 2% by mass of friction-modifying additive, relative to the total weight of the composition.

Advantageously, a cooling composition is free of friction-modifying additive, in particular for a use directed toward cooling the battery part.

A cooling composition according to the invention may comprise at least one detergent additive.

The detergent additives generally make it possible to reduce the formation of deposits on the surface of metal parts by dissolving the oxidation and combustion byproducts.

The detergent additives that may be used in a cooling composition are generally known to those skilled in the art. The detergent additives may be anionic compounds comprising a long lipophilic hydrocarbon-based group and a hydrophilic head. The associated cation may be a metal cation of an alkali metal or an alkaline-earth metal.

The detergent additives are preferentially chosen from alkali metal or alkaline-earth metal salts of carboxylic acids, sulfonates, salicylates and naphthenates, and also phenate salts. The alkali metals and alkaline-earth metals are preferentially calcium, magnesium, sodium or barium.

These metal salts generally comprise the metal in a stoichiometric amount or in excess, thus in an amount greater than the stoichiometric amount. They are then overbased detergent additives; the excess metal giving the overbased nature to the detergent additive is then generally in the form of a metal salt that is insoluble in the oil, for example a carbonate, a hydroxide, an oxalate, an acetate or a glutamate, preferentially a carbonate.

A cooling composition may comprise, for example, from 2% to 4% by mass of detergent additive, relative to the total mass of the composition.

A cooling composition may also comprise at least one pour-point depressant additive.

By slowing down the formation of paraffin crystals, the pour-point depressant additives generally improve the cold-temperature behavior of the composition. Examples of pour-point depressant additives that may be mentioned include polyalkyl methacrylates, polyacrylates, polyarylanides, polyalkylphenols, polyalkylnaphthalenes and polyalkylstyrenes.

Also, a cooling composition may comprise at least one dispersant.

The dispersant may be chosen from Mannich bases, succinimides and derivatives thereof. A cooling composition may comprise, for example, from 0.2% to 10% by mass of dispersant relative to the total mass of the composition.

According to a particular embodiment, a cooling composition used according to the invention comprises, or even is formed from, (i) at least one ester according to the invention, in particular at least one branched ester as defined previously, and more particularly a branched monoester as defined previously and (ii) at least one additive chosen from antioxidants, antifoams, pour-point-depressant additives, anticorrosion agents, wear-resistance and/or extreme-pressure additives, friction modifiers, detergents, dispersants and mixtures thereof, preferably from antioxidants, pour-point-depressant additives, antifoams and anticorrosion agents.

Advantageously, a cooling composition used according to the invention is formed from (i) at least one ester according to the invention, in particular from at least one branched ester as defined previously, and more particularly a branched monoester as defined previously, and (ii) at least one antioxidant additive.

According to a particular embodiment, a cooling composition used according to the invention comprises, or even consists of;
at least 30% by mass, preferably at least 50% by mass, preferably at least 70% by mass, preferably at least 80% by mass, more preferentially at least 90% by mass, or even at least 95% by mass, of one or more esters according to the invention, in particular of one or more branched esters according to the invention;
from 0.01% to 10% by mass, preferably from 0.05% to 5% by mass, of one or more additives chosen from antioxidants, antifoams, wear-resistance and extreme-pressure additives, friction modifiers, detergents, pour-point-depressant additives, dispersants and mixtures thereof, preferably chosen from antioxidants, antifoams, pour-point-depressant additives, anticorrosion agents and mixtures thereof; and
optionally from 5% to 70% by mass, preferably from 10% to 50% by mass, preferably from 15% to 30% by mass of base oil(s) other than the ester according to the invention, the contents being expressed relative to the total mass of said composition.

A cooling composition used according to the invention advantageously has a kinematic viscosity, measured at −25° C. according to the standard ASTM D445, of less than or equal to 200 mm²/s, in particular less than or equal to 120 mm²/s, notably ranging from 20 to 100 mm²/s and more particularly from 40 to 70 mm²/s.

Advantageously also, a cooling composition used according to the invention has a kinematic viscosity, measured at 25° C. according to the standard ASTM D445, of less than or equal to 20 mm²/s, in particular less than or equal to 15 mm²/s, notably ranging from 2 to 12 mm²/s and more particularly ranging from 5 to 10 mm²/s.

Moreover, a cooling composition used according to the invention has a particularly high auto-ignition temperature. In particular, a cooling composition according to the invention advantageously has an auto-ignition temperature of greater than or equal to 360° C., in particular greater than or equal to 380° C. and more particularly greater than or equal to 400° C.

Application

As indicated previously, a composition according to the invention may be used as a cooling fluid for a propulsion system of an electric or hybrid vehicle.

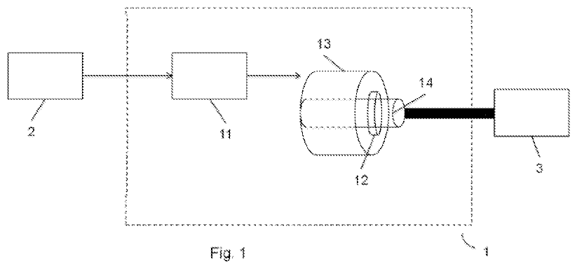

As represented schematically in FIG. 1, the propulsion system of an electric or hybrid vehicle notably comprises the electric motor part (1), an electric battery (2) and a transmission, and in particular a speed reducer (3).

The electric motor typically comprises power electronics (11) connected to a stator (13) and a rotor (14). The stator comprises coils, in particular copper coils, which are powered by an alternating electric current. This makes it possible to generate a rotating magnetic field. For its part, the rotor comprises coils, permanent magnets or other magnetic materials, and is placed in rotation by the rotating magnetic field.

The power electronics (11), the stator (13) and the rotor (14) of a propulsion system (1) are parts of complex structure which generate a large amount of heat during the running of the motor. It is thus imperative to ensure cooling of the electric motor and of the power electronics.

A rolling bearing (12) is generally incorporated between the stator (13) and the rotor (14). A transmission, and in particular a speed reducer (3), makes it possible to reduce the rotation speed at the outlet of the electric motor and to adapt the speed transmitted to the wheels, making it possible simultaneously to control the speed of the vehicle.

Advantageously, a composition according to the invention may be used for cooling the battery of an electric or hybrid vehicle. In particular, it is intended to be placed in direct contact with the battery.

As batteries that are suitable for the propulsion systems of an electric or hybrid vehicle, mention may be made in particular of Li-ion batteries or nickel-cadmium batteries.

According to another of its aspects, the invention also relates to a process for cooling at least one part of a propulsion system of an electric or hybrid vehicle, in particular the battery, comprising at least one step of placing at least said part, in particular said battery, for example a lithium-ion or nickel-cadmium battery, in contact with a composition comprising at least one branched ester according to the invention, as defined previously.

The step of placing the cooling composition according to the invention in contact with the battery may consist of immersion or semi-immersion of the battery in said composition or else of injection of said composition at the surface of the battery.

The term “immersion” means that all of the battery is surrounded with the cooling composition according to the invention. The term “semi-immersion” means that only part of the battery is in contact with said composition.

The cooling may be performed via any method known to those skilled in the art. The battery may be in immersion or semi-immersion, static or in circulation, in said composition.

As examples of placing in direct contact, mention may be made of cooling by injection, by jet, by spraying or by formation of a mist using the composition according to the invention under pressure and by gravity on the battery.

Advantageously, the composition is injected by jet at relatively high pressure into the zones of the propulsion system to be cooled. Advantageously, the shear resulting from this injection makes it possible to reduce the viscosity of the fluid in the injection zone, relative to the kinematic viscosity at rest, and thus to further increase the cooling potential of the composition.

Furthermore, oil-circulating systems commonly used in electric motors may be employed, as described, for example, in WO 2015/116496.

A composition according to the invention may also be used for cooling the electric motor of an electric or hybrid vehicle, in particular for cooling the power electronics and/or the rotor and/or the stator of the electric motor.

The cooling composition according to the invention notably has electrical insulating properties that are particularly satisfactory for use in electric or hybrid vehicles.

Besides the cooling properties of a composition according to the invention, it is possible to exploit its lubricant properties.

Thus, a composition according to the invention may be used simultaneously for lubricating the various parts of a propulsion system of an electric or hybrid vehicle, in particular the rolling bearings located between the rotor and the stator of an electric motor, or else the transmission, in particular the reducer, in an electric or hybrid vehicle.

In the case of such an application, a cooling composition according to the invention also advantageously comprises one or more additives chosen from wear-resistance additives, friction modifiers, detergents, dispersants, extreme-pressure additives, and mixtures thereof.

The invention will now be described with the aid of the examples that follow, which are, needless to say, given as nonlimiting illustrations of the invention.

### Example

Various compositions, formed from the following compounds, were evaluated:
a branched ester A, in accordance with the invention: 3,5,5-trimethylhexyl 3,5,5-trimethylhexanoate;
an ester B, in accordance with the invention: dibutylglycol adipate, which is a diester formed between a dicarboxylic acid containing a non-branched alkylene chain of 6 carbon atoms and a butylglycol monoalcohol;
a poly-α-olefin C of hydrogenated decene dimer type, conventionally used for these battery cooling applications;
an ester D, not in accordance with the invention: diisodecyl adipate, which is a diester formed between a dicarboxylic acid containing a non-branched linear alkylene chain of 6 carbon atoms and a monoalcohol containing a branched alkyl chain containing 10 carbon atoms;
an ester E not in accordance with the invention, which is a diester formed between neopentyl glycol and 3,5,5-trimethylhexanoic acid; and
an ester F not in accordance with the invention, which is a triester formed between trimethylolpropane and 3,5,5-trimethylhexanoic acid.

The stability of the compositions at high temperatures, in other words their resistance to ignition, is evaluated by determination of their auto-ignition temperature according to the standard ASTM E659.

The viscosities of the compositions at 25° C. and at −25° C. are determined according to the standard ASTM D 445.

The results of the auto-ignition temperature and cold-temperature viscosity measurements are collated in table 2 below.

TABLE 2

| Compositions | A | B | C | D | E | F |
|---|---|---|---|---|---|---|
| Auto-ignition | 401.5 | 356.0 | 216.0 | 357.0 | 389 | 400 |
| temperature (° C.) | | | | | | |
| Viscosity at −25° C. | 55.8 | 146.2 | 81.6 | 525.6 | 908.9 | >1000 |
| (mm²/s) | | | | | | |
| Viscosity at 25° C. | 6.7 | 10.9 | 8.0 | 23.5 | 23.5 | 117.2 |
| (mm²/s) | | | | | | |

The branched ester A and the ester B, in accordance with the invention, have a low cold-temperature viscosity, while at the same time having a high auto-ignition temperature, which makes each of these esters compatible with its use in a battery and/or the power electronics of an electric or hybrid vehicle.

The stability and the resistance to ignition of the esters A and B are thus ensured, even in the case of overheating of the battery.

It will more particularly be noted that an ester as defined in the present invention has viscosity and auto-ignition properties that are particularly advantageous for its use in a cooling composition of a propulsion system, in particular of a battery and/or the power electronics, of electric or hybrid vehicles.

1-19. (canceled)

20. A method for cooling a propulsion system of an electric or hybrid vehicle, the method comprising cooling the battery and/or the power electronics of the electric or hybrid vehicle using a composition comprising an ester having a kinematic viscosity, measured at −25° C. according to the standard ASTM D445, of less than or equal to 200 mm²/s, and an auto-ignition temperature, measured according to the standard ASTM E659, of greater than or equal to 350° C.

21. The method of claim 20, wherein the composition comprises at least 30% by mass of the ester, relative to the total weight of the composition.

22. The method of claim 20, wherein the cooling comprises cooling a lithium-ion or nickel-cadmium battery of the electric or hybrid vehicle.

23. The method of claim 20, wherein the ester has a kinematic viscosity, measured at −25° C. according to the standard ASTM D445, of less than or equal to 150 mm²/s, and/or an auto-ignition temperature, measured according to the standard ASTM E659, of greater than or equal to 360° C.

24. The method of claim 20, wherein the ester is chosen from: a monoester; an ester comprising at least one heteroatom other than the oxygen atoms of an ester group of the ester; or mixtures thereof.

25. The method of claim 24, wherein the monoester is a branched monoester formed between at least one carboxylic acid including at least one saturated or unsaturated, branched hydrocarbon-based chain, and at least one alcohol including at least one linear or branched, saturated or unsaturated hydrocarbon-based chain.

26. The method of claim 24, wherein the monoester is formed from:
a monocarboxylic acid including at least one linear or branched hydrocarbon-based chain, of 1 to 14 carbon atoms; and
a monoalcohol including a branched or un-branched hydrocarbon-based chain of 1 to 14 carbon atoms.

27. The method of claim 24, wherein the ester is a monoester, a diester, or a triester.

28. The method of claim 24, wherein the ester is formed from at least one carboxylic acid and from at least one alcohol comprising at least one ether functional group.

29. The method of claim 20, wherein the ester is represented by Formula (I) below:
G¹-C(O)—O-G², wherein: Formula 1:
G1 represents a saturated or unsaturated hydrocarbon-based chain, the hydrocarbon-based chain being optionally interrupted with one or more heteroatoms, and/or optionally bearing one or more groups R1-O—C(O)—, with R1 representing a saturated or unsaturated, branched or non-branched hydrocarbon-based chain that is optionally interrupted with one or more heteroatoms; and
G2 represents a saturated or unsaturated, linear or branched, hydrocarbon-based chain, the hydrocarbon-based chain being optionally interrupted with one or more heteroatoms, and/or optionally bearing one or more groups —O—C(O)—R2, with R2 representing a saturated or unsaturated, branched or non-branched, hydrocarbon-based chain that is optionally interrupted with one or more heteroatoms.

30. The method of claim 29, wherein:
G1 represents an alkyl group; and
G2 represents a linear or branched alkyl group.

31. The method of claim 20, wherein the ester is a monoester formed between a saturated branched C₈ to C₁₀ monocarboxylic acid, and a saturated branched C₈ to C₁₀ monoalcohol.

32. The method of claim 29, wherein:
G2 represents an alkyl chain including from 1 to 14 carbon atoms, the chain being interrupted with at least one oxygen atom; and
G1 represents a group R1-O—C(O)-A1-, with A1 representing an alkylene group, and R1 representing a saturated or unsaturated, branched or non-branched hydrocarbon-based chain, optionally interrupted with one or more heteroatoms.

33. The method of claim 20, wherein the ester is a diester formed between a saturated linear C₄-C₁₀ dicarboxylic acid, and a monoalcohol comprising a saturated linear C₄-C₁₀ hydrocarbon-based chain that is interrupted with an oxygen atom.

34. The method of claim 20, wherein the composition further comprises an additive chosen from antioxidants, pour-point-depressant additives, antifoams, anticorrosion agents, wear-resistance and/or extreme-pressure additives, friction modifiers, detergents, dispersants, or mixtures thereof.

35. A composition for cooling a propulsion system of an electric or hybrid vehicle, the composition comprising:
an ester having a kinematic viscosity, measured at −25° C. according to the standard ASTM D445, of less than or equal to 200 mm²/s and an auto-ignition temperature, measured according to the standard ASTM E659, of greater than or equal to 350° C.; and
an additive chosen from antioxidants, pour-point-depressant additives, antifoams, anticorrosion agents, wear-resistance and/or extreme-pressure additives, friction modifiers, detergents, dispersants, or mixtures thereof.

36. The composition of claim 35, wherein the ester has a kinematic viscosity, measured at −25° C. according to the standard ASTM D445, of less than or equal to 150 mm²/s, and/or an auto-ignition temperature, measured according to the standard ASTM E659, of greater than or equal to 360° C.

37. The composition of claim 35, wherein the composition is formed from the ester and from one or more antioxidant additives.

38. The composition of claim 35, wherein the composition comprises more than 30% by mass of the ester, based on the total weight of the composition.

39. The composition of claim 35, wherein the composition comprises at least 70% by mass of the ester, based on the total weight of the composition.
